(19) United States
(12) Patent Application Publication
(10) Pub. No.: US 2004/0167872 A1
(43) Pub. Date: Aug. 26, 2004

(54) Accessing meta information triggers automatic buffering

(76) Inventor: Yevgeniy Eugene Shteyn, Cupertino, CA (US)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/788,879

(22) Filed: Feb. 27, 2004

Related U.S. Application Data
(63) Continuation of application No. 09/741,985, filed on Dec. 20, 2000.

(51) Int. Cl. G06F 7/00

(52) U.S. Cl. 707/1

(57) ABSTRACT

A “content re-entry” feature is provided that allows a user to return to an indicated point in a content stream, after being “distracted” by meta-information. Each time a user, or application, begins to follow a related or alternative content (a distraction path), a re-entry point in the original content stream is recorded, thereby facilitating a return to the point at which the distraction occurred. In a broadcast presentation, an access to meta-information is integrated with the storage of content material. Each time a user requests access to meta-information, a recording device is automatically activated to record the content material and to store the location of the start of the recording. When the user terminates the presentation of the meta-information, the presentation of the content material is automatically resumed at the stored location. The recording of the content material continues while the content material is being viewed, so as to provide a continuous, albeit time-shifted, presentation of the content material after the presentation is resumed. In a controllable streaming presentation, the streaming is terminated while the distraction path is being followed, then resumed at the point at which it had been terminated.

### BACKGROUND OF THE INVENTION

1. Field of the Invention

This invention relates to the field of consumer electronics, and in particular to a system and method for automating the buffering of content material when meta-information concerning this content material is accessed.

2. Description of Related Art

Real time buffering of content information for subsequent, or time-shifted, presentation to a user is becoming increasingly common. The TiVo® video storage device, and similar products, allow a user to “pause” the presentation of a television broadcast, while answering a telephone call, for example, and then resume the presentation from the point of pause. This simulated “pause” of a television broadcast is effected by storing the broadcast as it is being received, then playing it back when the user resumes the presentation. As contrast to a conventional VCR, however, the TiVo® and like products continue to record the broadcast while the playback is occurring, so that the user is presented a continuous time-shifted presentation of the broadcast material. Subsequent pauses extend the time-shift, and “fast-forwards” through commercials and the like, shorten the time-shift.

The integration of devices in a home environment is also becoming increasingly common. The HAVi architecture, the Home API initiative and UPnP, the Universal Serial Bus (USB), HomeRF Lite, and the Bluetooth standard, each involving substantial contributions from Philips Electronics, the Jini technology of Sun Microsystems, Inc., and others, have been developed to enhance the interoperability of multiple devices in a network. Via these control networks, or via point-to-point communications between devices, a user can access a variety of information and entertainment sources conveniently.

The coupling of multiple sources of information to content information is also becoming increasingly common. For example, a conventional DVD recording often includes ancillary information regarding the production of the content material, the backgrounds of the performers, as well as references to other sources of information. This ancillary information, or the locators for ancillary information, is commonly referred to as “meta-information”. In the broadcast field, the broadcast of content information is also accompanied by the simultaneous broadcast of metainformation related to the content information. In some broadcast scenarios, such as VBI, WebTV, and HDTV, the meta-information is contained within the broadcast of the content information, in other scenarios, it is broadcast on a separate communications channel, such as the MSFT Barney doll method used for transmitting the meta information via a radio broadcast. In some scenarios, a web site on the Internet contains information that is related to material that is broadcast via radio or television. For example, a television broadcast studio or network may provide a site that contains information related to the content material that has been, or will be, broadcast within a coincident span of time. A newscaster often, for example, ends a newscast with an announcement that additional information regarding the stories in the newscast may be found at a particular URL (e.g. “www.kxbsnews.com”).

Web-TV of Philips Magnavox is an example of a device that supports the synergy between conventional television on the one hand and the Internet on the other. The Philips Magnavox WebTV Plus Receiver offers a WebPIP (picture in picture) feature. A user can watch a television program simultaneously with maintaining a connection to the Web, even if their television set does not have PIP capability. This enables, for example, watching a TV show and being able to retrieve your E-mail at the same time without ever having to leave the living room couch. The receiver comes with an Electronic Program Guide (EPG) that allows users to receive text and video information about all the programs available on their TV system. The EPG is updated daily from the Web. The EPG is continuously available to the user while offline. Further expanding users' online capabilities, the integrated WebTV Crossover Links feature provides instant access to Web sites when users click on embedded links in television programs or commercials. For example, one could watch a TV documentary on the space program and simultaneously link up to the NASA Web site for additional information on a specific topic. Or, consumers shopping for a new car could click on the Web site link in an advertiser's TV commercial and instantly get more information on availability, options, and local dealers. Additionally, vendors may provide information that facilitates the purchase of an advertised item, via an associated URL to an Internet site. A user can view or hear an advertisement, connect to the associated URL and immediately purchase the item. In like manner, the user can access multiple dedicated shopping channels, content streaming servers, as well as pre-recorded material.

Generally, the PIP is placed in a corner of the screen, so as not to obscure the presentation of the content material, or the presentation of the content material is shrunk so as to allow room for the PIP without obscuring the presentation of the content material. Also commonly, users access the meta-information during commercial breaks, so as not to interfere with the presentation of the content material. Alternatively, the meta-information is presented on a different device than the content material, to reduce the disruptions caused by an access to the meta-information. The disruptions caused by a meta-information access diminish the attractiveness of a meta-information providing service or product. Additionally, even if the user has access to meta-information, the frequency of access is often consciously or unconsciously limited, in order to minimize the access-induced disruptions. The disruptive effects, and the corresponding minimization of meta-information access, also limits the success of the commercial use of meta-information access, such as the aforementioned purchasing meta-information that facilitates and encourages “impulse buying”.

### BRIEF SUMMARY OF THE INVENTION

It is an object of this invention to enhance the ease of access to meta-information. It is a further object of this invention to provide access to meta-information with minimal interference to the presentation of the related content material. It is a further object of this invention to enhance the automation of a user's environment.

These objects and others are achieved by providing a “content re-entry” feature that allows a user to return to an indicated point in a content stream, after being “distracted” by metainformation. Each time a user, or application, begins to follow a related or alternative content (a distraction path), a re-entry point in the original content stream is recorded, thereby facilitating a return to the point at which the distraction occurred. In a broadcast presentation, an access to meta-information is integrated with the storage of content material. Each time a user requests access to meta-information, a recording device is automatically activated to record the content material and to store the location of the start of the recording. When the user terminates the presentation of the meta-information, the presentation of the content material is automatically resumed at the stored location. The recording of the content material continues while the content material is being viewed, so as to provide a continuous, albeit time-shifted, presentation of the content material after the presentation is resumed. In a controllable streaming presentation, the streaming is terminated while the distraction path is being followed, then resumed at the point at which it had been terminated.

### BRIEF DESCRIPTION OF THE DRAWINGS

The invention is explained in further detail, and by way of example, with reference to the accompanying drawings wherein:

FIG. 1 illustrates an example flow diagram of a re-entrant system in accordance with this invention.

FIG. 2 illustrates an example block diagram of a system that facilitates access to meta-information related to content material, in accordance with this invention.

FIG. 3 illustrates an example flow diagram that facilitates access to meta-information related to content material, in accordance with this invention.

Throughout the drawings, the same reference numerals indicate similar or corresponding features or functions.

### DETAILED DESCRIPTION OF THE INVENTION

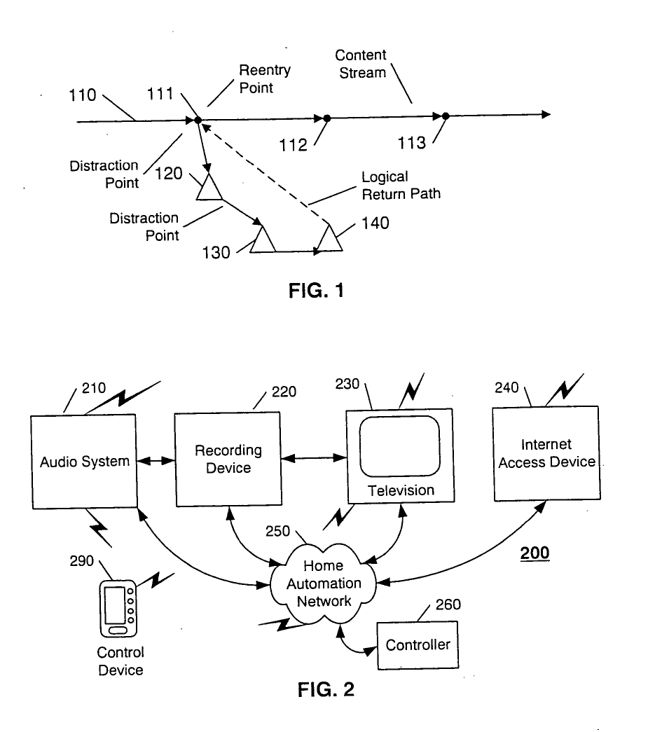

FIG. 1 illustrates an example flow diagram of a reentrant system in accordance with this invention. A content stream is illustrated by the continuous horizontal line (path) 110. The content stream can be delivered to a user by broadcast, point-to-point streaming, reading from a fixed or removable media, combinations of deliveries, and so on. At some point 111, a user is distracted, and departs the path 110 of the content material to follow a path to another point 120. A URL (Universal Resource Locator) related to the main narrative of the content material may comprise the distraction point 111. Another example of a distraction point may be an advertisement, introduced between main segments of the content material. In another example, the distraction point 111 may be an interactive application related to the content material, such as an interactive game that is played concurrent with a television game show. For example, in a quiz show, the at-home viewer/contestant playing the interactive game may be provided time to research an answer, or may be provided the URL of a source for additional clues. In accordance with this invention, the content material (the television game) is ‘frozen’ while the user plays the interactive portion, and resumed at the user's command, or resumed in accordance with a time limit that is established for the interactive game. The distraction (e.g. the interactive game) may be initiated by a user command, or it may be provided by an application program that is coupled to meta-information that is broadcast with the content material. Note that while the game is frozen, the user may use the same display device (the television) to access and view the ‘distraction’ material.

Although this invention is particularly well suited for accessing meta-information that is related to content material, the distraction may be unrelated to the content material, such as when a viewer recalls something that he or she had forgotten to do, such as sending a birthday card via the Internet, and decides to do it immediately, before he or she forgets again. In this example, the meta-information preferably includes a collection of commonly accessed URLs, or sponsored URLs, that facilitate general shopping or searching tasks. In a preferred embodiment, the user equipment is configured to store such commonly accessed URLs, to allow access to these URLs independent of the current content of the meta-information and independent of the currently accessed content material. For ease of reference, the invention is presented hereinafter using the paradigm of content-related meta-information, although it is not limited to the examples presented.

As indicated by the points 130, 140, subsequent distraction paths may be taken. At some point 140, the user reenters the path 110 at the point 111 of the original distraction. In a preferred embodiment, the system allows the user, or an application, to save multiple reentry points, thereby allowing the user or application to review material if desired. Although the reentry point is illustrated at the same point 111 as the original distraction, the stored reentry point may be modified by the user or by an application. For example, if the user is distracted during a commercial break, the system may be configured to overwrite the stored reentry point with a point at the end of the commercial break. In like manner, reentry points may be defined at the start of each scene of a broadcast. If the user is distracted during the scene, the system is configured to return to the start of the scene, to provide continuity. Preferably, the content material will be configured to mark such likely re-entry points, to facilitate continuity. Similarly, if the content material includes related meta-information, alternative re-entry points may be provided. For example, if the meta-information relates to a character that appears in the content material, an alternate re-entry point may be provided corresponding to the first appearance of the character in the content material. These and other reentry schemes will be obvious to one of ordinary skill in the art in view of this disclosure.

The invention may be embodied in a single device, such as a personal computer (PC) that is configured to provide control, access, recording, and presentation capabilities; or as a sub-system, such as a set-top-box (STB) that is configured to interact with a receiving and presentation device, such as a television; or as a network of devices that can be configured or controlled to interact with each other; or as any of a variety of combinations of functional elements that provide the capabilities discussed hereinafter. For ease of understanding and illustration, the invention is presented herein using the paradigm of a home network environment comprising a variety of devices that receive commands and transfer information via a local network.

FIG. 2 illustrates an example system 200 that facilitates access to meta-information while accessing content material. The example system 200 includes a variety of devices 210-240 that are interconnected via an example home network 250. Illustrated in FIG. 2 is a control device 290 that is configured to receive user input and to communicate commands corresponding to this input to one or more of the devices 210-240, either directly, via for example an infrared (IR) link to receptors on the devices 210-240, or via an interface provided at the home network 250. As would be evident to one of ordinary skill in the art, the control device 290 may be embodied in one or more of the devices 210-240 as well.

A controller 260 is illustrated as a separate item in FIG. 2, although it may be, and preferably is, embodied in one or more of the devices 210-240, 290, or in another device, such as a PC on the network, or as an independent device. For example, the control device 290 may be a programmable portable control device, and the controller 260 may be embodied in the control device 290 by downloading a program that provides the functions of the controller 260 to the device 290. Or, the recording device 220, or any other device, may be configured to receive commands from the control device 290 and to process the commands for transmission to other devices in the network 250. The invention is presented hereinafter using the paradigm that the controller 260 is a separate device, for ease of distinguishing the functions that are provided by the controller 260, regardless of the particular embodiment chosen.

In like manner, the recording device 220 is illustrated as an independent device, such as a TiVo-like device, although it could be embodied as a storage device within any of the other devices 210, 230, 240, or another device, such as a file server, on the network 250.

The controller 260, in accordance with this invention, is configured to monitor user commands, or requests, and to initiate a recording of content material whenever a request for access to meta-information is received. The recording of the content material is preferably effected via a TiVo-like recording device 220, that allows subsequent simultaneous recording and playout, wherein the playout is a time-shifted version of the recorded material, as discussed above in the Background of the Invention.

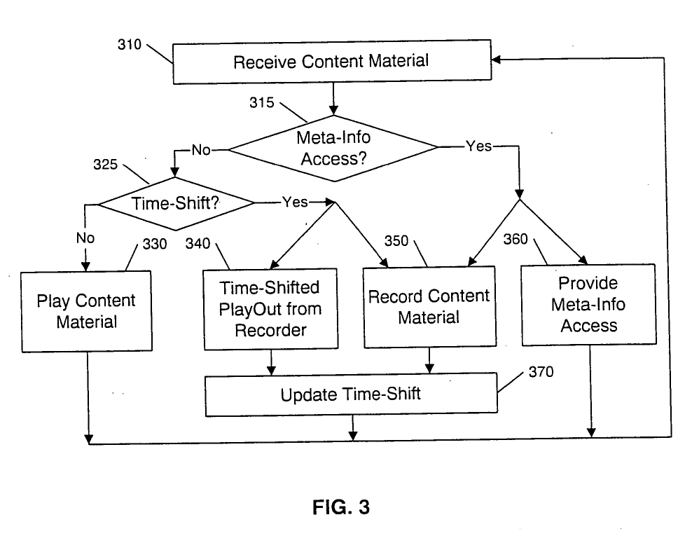

The operation of the controller 260 within the context of the system 200 is best understood with regard to the flow diagram of FIG. 3. For ease of understanding, the initial digit of the reference numerals refer to the corresponding figure in which the reference can be found.

At 310, the system 200 continuously receives content material, via, for example, the television device 230, the audio system 210, or via an on-line presentation via the Internet access device 240. This content material may be a television program broadcast, via conventional RF, satellite, or cable connections, a radio program broadcast, and so on. Associated with this content material is meta-information, which, as discussed above, may be embedded within the content material, transmitted simultaneously on another channel from the content material, or otherwise associated with the content material. The meta-information may be, for example, information related to the performers, production personnel, particular scenes, similar programs, and other items related to the currently received content material, such as discussed above with regard to information that facilitates interaction with broadcast material. The meta-information may also be related to future or past content material, such as a program guide, advertising information related to the sponsors of the content material, and so on.

Note that although the invention is presented using the paradigm of a home network system, the principles of this invention are not limited to this particular application. For example, the content material may be a continuous download of data, such as current stock-market prices, and the meta-information may be background information related to particular listed equities.

At 315, the controller 260 determines whether an access to meta-information has been requested. Preferably, the controller 260 maintains a state variable that corresponds to whether the user has requested, and not terminated, access to the meta-information, and this variable is used at the test block 315. This state determination may be effected by intercepting the commands communicated from the control device 290, or by monitoring the status of the meta-information providers, such as the Internet access device 240, or a reported status from a meta-information access device within the receiver of the content material, and so on.

If meta-information is being accessed, the controller 260 effects a simultaneous recording of the content material, at 350, and access to the meta-information, at 360. For example, the controller 260 communicates a ‘record’ command to the recording device 220, records the start point of the recording as the reentry point, and communicates Internet access commands to the Internet access device 240. If the recording device 220 is capable of recording content material from either the television 230 or the audio system 210, the controller 260 also communicates the appropriate source-selection commands to the recording device 220. In a preferred embodiment, the controller 260 is configured to monitor user selections of active devices, and automatically communicates the appropriate selection commands to the recording device 220 whenever the user selects a device 210, 230, thereby pre-configuring the recording device 220 to have the appropriate input when the aforementioned record command is received.

While the meta-information is being accessed, the controller 260 maintains the recording and Internet access, via the 310-315-(350-370, 360)-310 loop. Depending upon the particular devices 210-240, this state-maintenance may be effected by merely not communicating a change of state to the recording device 220 and the meta-access device. When the controller 260 detects a termination of the meta-information access, it changes the aforementioned meta-information state variable, to effect the subsequent result of the decision block 315.

In a preferred embodiment, the recording device 220 maintains a ‘time-shift’ reference, at 370, typically by maintaining two pointers to the recording media within the device 220. A record-pointer identifies the memory location to which the content material is stored, and the playout-pointer identifies the memory location from which the recorded material is played out. In a preferred embodiment, while the user is accessing meta-information, at 360, the content material is being recorded, at 350; but, whether or not the presentation of the content material continues is dependent upon a user selection (not shown). That is, in accordance with this invention, the content material is continually recorded while the meta-information is being accessed, but the content material may also be continually presented to the user while the meta-information is being accessed, as in a conventional meta-information access system, described above. However, by automatically recording the content material, the user is provided the option of re-playing the content material, should the user's attention be diverted to the meta-information at unfortunate times, such as during a key sports play, or some other unpredictable event. Alternatively, the user is provided the option of having the controller 260 automatically “pause” the presentation of the content material at the same time that it automatically starts the “record” of the content material. If the system automatically pauses the presentation of the content material, the playout-pointer will equal the aforementioned stored reentry time. If the system is configured to continue to playout the material while the meta-information is being accessed, the user is provided the option of restoring the playout-pointer to the stored reentry time.

If meta-information is not being accessed, at 315, the controller 260, or the recording device 220, determines whether there's a remaining time-shift between the content material that is to be presented and the content material that is being received. If there is no time-shift, at 325, the content material that is being received is presented directly to the user, at 330. If, at 325, it is determined that a time-shift exists, the controller 260, or the recording device 220, effects a simultaneous playout of the recorded material, at 340, and recording of the content material, at 350. Not illustrated, the user has the option of “fast-forwarding” the playout of the recorded material, thereby reducing the time-shift between the material being presented and the material being received. The system continues to receive and present and/or record the content material via the loop 310-315-325-330-310, or via the loop 310-315-325-(340, 350)-370-310, until the user again requests access to meta-information.

If the content material is being provided via a controllable streaming source, the storage of the start time as the reentry point is generally sufficient to effect the reentry into the content material path. For example, communicating the URL of the source and the reentry point, or corresponding index, to the network of the source, typically effects the resumption of the streaming of the content material from the reentry point, or index. If the streaming source is a local playback device, such as a DVD, the start time is used to reposition the playback mechanism to the appropriate reentry point. Note that, if the system is configured to automatically pause the streaming source, the reentry can be effected by merely providing a ‘resume’ command. In effect, the paused device in this example stores the reentry point, as either an actual value, or, in the example of a paused VCR, as a mechanical state.

As presented, the invention provides a means for accessing meta-information, which minimizes the disruptive effects on the presentation of content material. This invention provides a more user-friendly alternative than the conventional approach of displaying either the content material or the meta-information in a PIP presentation. It also increases the appeal and practicality of TiVo-like devices, and offers a practical and efficient combination for integrating TiVo-like capabilities with Internet access devices, such as WebTV set-top-boxes. Additionally, it increases the likelihood that users may act upon impulse-buy decisions, knowing that the activation of purchasing meta-information will merely introduce a time-shift in the presentation of the content material, and not an interruption, per se.

These advantages present unique opportunities for business models, in addition to the obvious option of providing products that combine the features of the devices 210-260 to produce the synergistic effects discussed above. For example, vendors may offer a control device 260 at a reduced price, or at no cost, to users, to facilitate the purchase of items via meta-information associated with advertising content material. Following the success of offering below-cost cellular telephones, and below-cost computers, to create market opportunities, vendors, including pay-per-view providers, shopping network sponsors, etc. may provide a combined control device 260 and recording device 220 to make impulse-buying a commonplace, and convenient, event.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A system for facilitating access to meta-information simultaneous with receipt of content material, comprising
a controller that is configured to:
store a reentry point corresponding to an index to the content material corresponding to an initiation of access to the meta-information, and
facilitate a subsequent receipt of the content material corresponding to the reentry point.

2. The system of claim 1, wherein
the controller is further configured to initiate a recording of the content material at the initiation of access to the meta-information.

3. The system of claim 2, wherein
the controller is further configured to initiate playout of the recording of the content material upon termination of access to the meta-information.

4. The system of claim 2, further including
a recording device that is configured to effect the recording of the content material.

5. The system of claim 1, wherein
the controller is further configured to initiate access to the meta-information.

6. The system of claim 1, further including
a rendering device that is configured to effect rendering of at least one of: the content material and the meta-information.

7. The system of claim 1, further including
an Internet access device that is configured to access the meta-information.

8. The system of claim 7, further including
a recording device that is configured to effect a recording of the content material.

9. The system of claim 1, wherein
the controller is coupled to a network, and, via commands that are communicated over the network, effects at least one of: the receipt of the request to access the meta-information, and a recording of the content material.

10. The system of claim 1, wherein
the meta-information facilitates a purchase of one or more items associated with the content material.

11. The system of claim 1, wherein
the controller is further configured to store access information based on the meta-information, to facilitate a subsequent access to information corresponding to the access information.

12. A method of facilitating access to meta-information, comprising:
receiving a request to access the meta-information while-accessing content material, and
storing a reentry value corresponding to the request, that facilitates a subsequent access to the content material corresponding to the reentry value.

13. The method of claim 12, further including
initiating a recording of the content material in response to the request to access the meta-information.

14. The method of claim 13, further including
initiating a playout of the recording of the content material upon termination of access to the meta-information.

15. The method of claim 12, further including receiving the content material.

16. The method of claim 12, further including accessing the meta-information.

17. A method of facilitating purchase of items, via access to meta-information, while accessing content material, comprising:
providing a control device that is configured to store a reentry value when the meta-information is accessed,
wherein the reentry value facilitates a subsequent access to the content material at a point corresponding to the reentry value.

18. The method of claim 17, wherein the control device is further configured to
commence a recording of the content material when the meta-information is accessed.

19. The method of claim 17, wherein
the control device is further configured to accept a user request to access the meta-information, and
the method further includes
accessing the meta-information based on the user request.

20. The method of claim 17, wherein
the control device is further configured to accept a user request to purchase an item related to the content material, and
the method further includes
effecting a purchase of the item based on the user request.

21. The method of claim 17, further including
providing a recorder for recording the content material.

22. Content material for processing by an end-user device comprising
an identification of one or more re-entry points in the content material,
wherein
the re-entry points facilitate a subsequent access to the content material, based on a distraction point corresponding to a user request while accessing the content material.

23. Content material as claimed in claim 22, wherein
the content material includes related meta-information, and
at least one of the re-entry points is based on the distraction point corresponding to an access to the meta-information.
